(19) United States
(12) Patent Application Publication
(10) Pub. No.: US 2026/0333008 A1
(43) Pub. Date: Oct. 22, 2026

(54) METHOD AND APPARATUS FOR PROACTIVE MOBILE NETWORK-ASSISTED INCIDENT MANAGEMENT

(71) Applicant: Continental Automotive Technologies GmbH, Hannover (DE)

(72) Inventors: Andreas Andrae, Frankfurt am Main (DE); David Gonzalez Gonzalez, Egelsbach (DE); Rikin Shah, Langen (DE)

(73) Assignee: Continental Automotive Technologies GmbH, Hannover (DE)

(21) Appl. No.: 19/100,587

(22) PCT Filed: Aug. 2, 2023
(86) PCT No.: PCT/EP2023/071456

§ 371 Date: Feb. 3, 2025

(30) Foreign Application Priority Data
Aug. 2, 2022 (DE) 10 2022 208 062.9

(51) Int. Cl. H04W 4/90; H04W 4/021; H04W 28/26; H04W 74/08; H04W 74/0833

(52) U.S. Cl. CPC H04W 4/90; H04W 4/021; H04W 28/26; H04W 74/0833; H04W 74/0875

(57) ABSTRACT

A smart infrastructure device, which is connected to a wireless communication network, performs proactive mobile network-assisted incident management. The smart infrastructure device detects objects in or around a geographical area, predicts critical events in the geographical area, and sends the predicted critical events to the wireless communication network. The wireless communication network, in particular a base station of the wireless network, explicitly indicates which resources of the wireless communication network are to be used by user equipment devices.

### CROSS-REFERENCE TO RELATED APPLICATIONS

The present application is a National Stage Application under 35 U.S.C. § 371 of International Patent Application No. PCT/EP2023/071456 filed on Aug. 2, 2023, and claims priority from German Patent Application No. 10 2022 208 062.9 filed on Aug. 3, 2022, in the German Patent and Trademark Office, the disclosures of which are herein incorporated by reference in their entireties.

### TECHNICAL FIELD

The application generally relates to wireless communications and, more particularly, to a smart infrastructure system and a wireless communications system.

### BACKGROUND

When user equipment (UE), i.e., a user equipment (UE) device, enters a cell of a communication network NW, such as LTE or 5G NR (New Radio), initial access to the network must be established.

In this text, the 5G NR terminology will be used for describing the technology. However, the method and apparatus will apply to different cellular based wireless communication systems using RACH-mechanisms for connecting user equipment to the network, i.e., to the base station gNB of the network, including 5G NR, 4G (LTE) and even 3G (UMTS/WCDMA).

Inter alia, initial and random access is established by a process between UE and gNB (network) for a UE to acquire uplink synchronization and obtain specified information for the radio access and communication. This process is performed via the so-called Random Access Channel (RACH). The typical contention-based RACH procedure contains the following 4 steps:

The UE selects a random access preamble from a set of predefined preambles including a random sequence number for the preamble and transmits the preamble on the PRACH (Physical Random Access Channel), which corresponds to Msg1. The base station gNB responds (Msg2) providing a Time Advance (TA) command for timing adjustment, a temporary identifier (called RA-RNTI (Random Access Radio Network Temporary Identifier)), and an initial uplink grant for the UE. Using this initial uplink grant, a UE sends a further message (Msg3) on PUSCH (Physical Uplink Shared Channel) with a certain RRC (Radio Resource Control) message, such as RrcRequest. The base station gNB responds with a further message (Msg4) for contention resolution containing the UE identity. At this step, the network provides UE with a C-RNTI (Cell Radio Network Temporary Identifier).

Alternatively, the typical contention free RACH procedure simplifies the over-the-air signaling, as the gNB pre-configured the UE to use a specific RACH preamble. In the first step, the UE sends RACH preamble and some data (incl. RA-RNTI, indication for L2/L3 message size), which is referred to as MsgA. In the second step, the gNB provides the Random Access Response (incl. TA, C-RNTI, UL grant for L2/L3 message), which is referred to as MsgB.

The random access procedure is triggered by a number of events:
Initial access from RRC_IDLE state;
RRC Connection Re-establishment procedure;
DL or UL data arrival, during RRC_CONNECTED or during RRC_INACTIVE while Small Data Transmission (SDT) procedure is ongoing, when UL synchronisation status is “non-synchronised”;
UL data arrival, during RRC_CONNECTED or during RRC_INACTIVE while SDT procedure is ongoing, when there are no PUCCH resources for Scheduling Request (SR) available;
SR failure;
Request by RRC upon synchronous reconfiguration (e.g., handover);
RRC Connection Resume procedure from RRC_INACTIVE state;
To establish time alignment for a secondary Time Alignment Group (TAG);
Request for Other System Information (SI);
Beam failure recovery;
Consistent UL LBT failure on SpCell;
SDT in RRC_INACTIVE state;

Positioning purpose during RRC_CONNECTED requiring random access procedure, e.g., when timing advance is needed for UE positioning.

RACH Occasion (RO) is an abstract 2D area specified in time and frequency domain that is available for the reception of the RACH preamble (PRACH) in the first step. In LTE, there is only one RACH occasion (RO) specified by RRC message (SIB 2) for all the possible RACH preambles. In 5G NR, the Synchronization Signal Blocks (SSBs) are associated with different beams. A UE selects a certain beam based on received signal strength and sends RA preamble on PRACH corresponding to the selected beam. The selected beam may correspond to a certain location in the network cell, which is correlated with a specific SSB. 3GPP defines a mapping between SSB and RACH Occasion (RO). By detecting to which RO the UE sends the RACH preamble, the gNBcan determine which SSB beam was selected by the UE, and where it is located in the network cell.

The mapping between SSB and RO is defined by the following two RRC parameters:
msg1-FDM,
ssb-perRACH-OccasionAndCB-PreamblesPerSSB.

Parameter “msg1-FDM” specifies how many RACH Occasions (ROs) are allocated in frequency domain (at the same location in time domain).

Parameter “ssb-perRACH-OccasionAndCB-PreamblesPerSSB” specifies how many SSBs can be mapped to one RO and how many preamble indices can be mapped to a single SSB. The higher these parameters are, the more congestion may occur for reception of the RACH preamble.

The overall mapping logic is described in 3GPP TS 38.213-8.1 and listed below:
First, in increasing order of preamble indexes within a single PRACH occasion.
Second, in increasing order of frequency resource indexes for frequency multiplexed PRACH occasions.
Third, in increasing order of time resource indexes for time multiplexed PRACH (RACH Preamble) occasions within a PRACH slot.
Fourth, in increasing order of indexes for PRACH slots.

As per 3GPP TS 38.331(v 17.1.0 , Sec. 5.2.1) the SIB1 is transmitted on the DL-SCH with a periodicity of 160 ms and variable transmission repetition periodicity within 160 ms as specified in 3GPP TS 38.213[13 ], clause 13. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period (3GPP TS 38.213[13 ], clause 13). SIB1 includes information regarding the availability and scheduling (e.g., mapping of SIBs to SI message, periodicity, SI window size) of other SIBs with an indication whether one or more SIBs are only provided on-demand and, in that case, the configuration needed by the UE to perform the SI request. SIB1 is cell-specific SIB.

This is visualized in FIG. 1 showing RACH Occasions for different settings of the RRC parameters.

In FIG. 1a, parameter “msg1-FDM=1” specifies that one frequency is used in the frequency domain, and parameter “ssb-perRACH-OccasionAndCB-PreamblesPerSSB=1” specifies that 1 slot in the frequency-time-domain is used for 1 SSB (sync signal) directed to one beam (of together 64 beams), each beam being related to a certain cell area or direction. This means that only one PRACH can be sent by one UE in one location (SSB X, X=0, . . . , 63) of the cell. In case of many UEs in one location there is congestion in the RACH (Random Access Channel).

In FIG. 1b, parameter “msg1-FDM=2” specifies that two frequencies are used in the frequency domain at one time, and parameter “ssb-perRACH-OccasionAndCB-PreamblesPerSSB=8” specifies that 1 slot in the frequency-time-domain is used for 8 SSBs (sync signals) directed to eight beams (of together 64 beams), i.e., UEs in eight (e.g., neighbored) areas share one RO in time and frequency domain. However, the repetition rate for PRACH is faster than in FIG. 1a.

In FIG. 1c, parameter “msg1-FDM=2” specifies that two frequencies are used in the frequency domain at one time, and parameter “ssb-perRACH-OccasionAndCB-PreamblesPerSSB=1” specifies that 1 slot in the frequency-time-domain is used for 1 SSB (sync signal) directed to one beam (of together 64 beams), each beam being related to a certain cell area or direction. This halves the repetition rate in comparison to FIG. 1a, but extends the repetition rate in comparison to FIG. 1b by a factor of 8 (allowing, however, to send a PRACH for one UE in each beam direction.

In FIG. 1d, parameter “msg1-FDM=2” specifies that two frequencies are used in the frequency domain at one time, and parameter “ssb-perRACH-OccasionAndCB-PreamblesPerSSB=0.5” specifies that 1 slot in the frequency-time-domain is used for 1 SSB (sync signal) directed to one beam (of together 64 beams), each beam being related to a certain cell area or direction. This means, that 2 UEs using the same beam (being related in the same cell area or direction) can send a PRACH simultaneously. This doubles the repetition rate in comparison to FIG. 1c.

The handling of the RACH Occasions (ROs), as described before, leads to the following problems, in particular in automotive applications, if critical situations are predicted.

If many UEs (such as vehicles, but also mobile phones or other network communication devices of participants in a traffic situation, such as pedestrians or cyclists) are present in one area of a cell of the network, and critical situations are predicted in this specific geographical area, a significant number of concurrent and urgent communications could be required (e.g., V2X warning messages via Uu interface), but not possible due to congestion. Such congestion may result in critical communication delays. Further, automotive radar users may face significant mutual interference, resulting in degraded radar performance. Both problems lead to an ineffective use of the wireless communication network.

### BRIEF SUMMARY

It is an object of the invention to provide more effective use of user equipments connected to the wireless communication network.

This invention gives a solution for this described problem accordingly. The disclosed concept addresses at least one of the two unsolved combined problems of congestion in mobile communications and interference among automotive radars.

The problem is in particular solved by the method for proactive mobile network-assisted incident management by a smart infrastructure device connected to a wireless communication network according to claim 1, wherein the smart infrastructure device detects objects in or around a geographical area, predicts critical events in said geographical area and sends the one or more predicted critical events (PCE) to the wireless communication network. The wireless communication network, in particular a base station of the wireless network, explicitly indicates which resources of the wireless communication network are to be used by a user equipment (UE). This enables the network to proactively provide or activate resources of the network for several types of functions in a given geographical area and in a UE-identity independent manner. This may include wireless communications, such as better RACH resources for initial and/or random access to the network by multiple (more than one) user equipments simultaneously (or within a very short time period) and/or sensing, such as using radio resources for automotive radar sensors. The benefits are faster network access (by providing better RACH resources) avoiding potential congestions and/or providing reduced interference during sensing with radar sensing using parts of the wireless communication spectrum. This is evident from the advantageous embodiments of the proposal as explained below.

According to one embodiment, explicitly indicating may comprise to assign additional and/or prioritized random access channel occasions for use by user equipments in said geographical area for initial and/or random access to the wireless communication network. The more RACH occasions are available, the more user equipment devices can randomly access the wireless communication network. It is utmost effective of offer this possibility in case of predicted critical events and related to such geographical areas where the critical events are predicted to possibly occur. This is in contrast to the RACH occasions in the frequency-time-domain distributed equally over the entire geographical area of the communication cell and leads to effective use of the resources.

In a specific proposal said additional and/or prioritized random access channel occasions may be pre-configured and indicated to the user equipment devices by the base station of the wireless communication network, e.g., in a broadcast transmission reaching all user equipment devices that may potentially request initial and/or random access to the wireless communication network. The broadcast transmission may be limited to said geographical area(s), for which (one or more) critical events are predicted.

Further, the base station may indicate which random access channel occasions are to be used by default and which ones are to be used for special, predicted critical events. The base station and/or network can determine and regularly update the configuration of random access channel occasions, e.g., based on historical event data, or when triggered by a predicted critical event. Accordingly, normal default access may be chosen for any unspecific access to communication network, e.g., for ordinary status reports. In case of critical events, such as an impending accident or high traffic density in front of a dangerous intersection, RACH occasions reserved for critical events can be used guaranteeing faster and prioritized network access.

In an advantageous embodiment, the base station or, more generally, the wireless communication network will activate and/or communicate said additional and/or prioritized random access channel occasions on the fly, if a predicted critical event is received by the wireless communication network.

On the fly means that receipt of a predicted critical event causes the base station or network to immediately reserve the additional RACH occasions in the frequency-time-domain of the communication network and/or communicate the activation/existence of the additional RACH occasions in a provided urgent communication process.

Predicting critical events may be realized in a user equipment device, in a base station of the wireless communication network and/or another wireless communication network device, such as a smart infrastructure device (SID) equipped with one or multiple object detecting sensors and a data processing unit, wherein the data processing unit may be adapted to perform an Artificial Intelligence (AI) algorithm for detecting, classifying, and/or tracking objects in or around a geographical area, such as an intersection. According, in line with the proposal, predicting of critical events may be done in any device that may be communicatively coupled to the wireless communication network.

In a specific embodiment of the proposal it may be provided that, if at least one (or preferably if at least two) user equipment(s) connected to a wireless communication network is a (or are) radar user equipment (UERs), the base station indicates to said radar user equipment(s) which radio resources and/or channels of the wireless communication network (NW) may be used for radar purposes. This may in particular be useful for specific radar technology, such as FMCW (Frequency Modulated Continuous-Wave) for radar sensing and/or OFDM (Orthogonal Frequency Division Multiplexing) for radar sensing and communications, in combination with a 5G NR wireless communication network, both (radar sensing and communications) working, e.g., with millimeter wave (mmWave), FR2, THz or future wireless communication bands. In case of possible interference of radar systems in different vehicles (as a predicted critical event), some of the radar sensing and/or communication entities may switch to different communication bands to avoid interference. In case of more than two possibly interfering radar systems, the base station of the communication network may manage different frequency bands for use with the different radar systems to guarantee interference free radar sensing. It is a major advantage of this solution that the increase of bandwidth is achieved by using frequencies that are usually used by the communication system so that these frequencies are flexibly reserved for use by other (non-telecommunication) appliances.

According to an advantageous proposal the base station reserves part of the radio spectrum originally assigned for wireless communication for radar usage, such as channels used for uplink or sidelink communications. In particular, part of the radio spectrum may be flexibly reserved for radar sensing purposes based on information or predicted critical events that are provided by a smart infrastructure device (SID).

In a preferred proposal, the base station may indicate the radio resources and/or channels to be usable for radar purposes to said radar user equipment (UERs) via system information blocks (SIBs) or user equipment specific signaling or paging, as defined in the wireless communication network.

The invention is also directed to an apparatus for use in a method for proactive mobile network-assisted incident management, said apparatus comprising a wireless transceiver for communicating in a wireless communication network, a processor coupled with a memory in which computer program instructions are stored, said computer program instructions being configured to implement method steps of claims 1 to 10 performed by the wireless communication network and/or the base station, or parts thereof. A base station of the wireless communication system may comprise an apparatus according to claim 11 as described before.

The invention may further provide an apparatus, said apparatus comprising one or multiple sensors (e.g., radar, camera, lidar, laser, ultrasound) for detecting, classifying, and/or track objects, a wireless transceiver for communication in a wireless communication network, a processor coupled with a memory in which computer program instructions are stored, said computer program instructions being configured to predict critical events in a geographical area and to provide corresponding event data to the wireless communication network according to method steps 5 and 6.

The invention is also directed to an apparatus, said apparatus comprising a radar sensor for detecting, classifying, and/or track objects in a radar sensor field, a wireless transceiver for communication in a wireless communication network, a processor coupled with a memory in which computer program instructions are stored, said computer program instructions being configured to receive indications of a base station of the radar sensor according to method steps as defined in claims 7 to 10 and to adapt the radar sensor to use the indicated radio resources and/or channels of the wireless communication network for radar detection and/or radar communication.

The invention may further provide an apparatus, said apparatus comprising a wireless transceiver for communication in a wireless communication network, a processor coupled with a memory in which computer program instructions are stored, said computer program instructions being configured to receive indications of a base station (gNB) of using additional and/or prioritized random access channel occasions (RO).

The invention is further directed to a wireless communication system for proactive mobile network-assisted incident management comprising a base station gNB as described before and at least one user equipment device, wherein said user equipment device comprises a processor coupled with a memory in which computer program instructions are stored, said instructions being configured to implement communication with the wireless communication network. Such wireless communication system may provide one of the user equipment devices as an apparatus according to claim 13, 14, and/or 15.

Further, the disclosure also contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station disclosed herein.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove. The information medium may be any entity or device capable of storing the program. For example, the medium can comprise a storage means, such as a ROM (Read Only Memory), for example a CD ROM or a microelectronic circuit ROM, EEPROM (Electrically Erasable Programmable Read-Only Memory), FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may be downloaded from a network.

Alternatively, the information medium may be an integrated circuit into which the program is incorporated, the circuit being arranged to execute or to be used in the execution of the methods in question.

### BRIEF DESCRIPTION OF THE DRAWINGS

Other advantages and characteristics of the invention will be more clearly apparent on reading the following description, given by way of simple illustrative and nonlimiting example, and the appended drawings.

FIGS. 1a, 1b, 1c, and 1d schematically show examples of the frequency-time-domain of RACH occasions according to the 3GPP 5G NR implementation.

FIG. 2 shows schematically interference among automotive radars according to one exemplary situation.

FIG. 3 shows schematically interference among automotive radars according to another exemplary situation.

FIG. 4 shows smart infrastructure equipped with object detection sensors and a data processing unit, e.g., a Multi-access Edge Computing (MEC) entity, used in a method according to the invention.

FIG. 5 shows system scenario with smart infrastructure providing the wireless communication network with critical event predictions.

FIGS. 6a, 6b, 6c, and 6d schematically show examples of the frequency-time-domain of RACH occasions according to an embodiment of the invention, in which a base station gNB or the wireless communication network explicitly indicates which resources to be used for random access and/or sensing.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc), Operations & Maintenance (O&M), Operations Support System (OSS), Self Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category MI, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc readonly memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. Although terminology from 3GPP 5G NR may be used in this disclosure to exemplify embodiments herein, this should not be seen as limiting the scope of the invention.

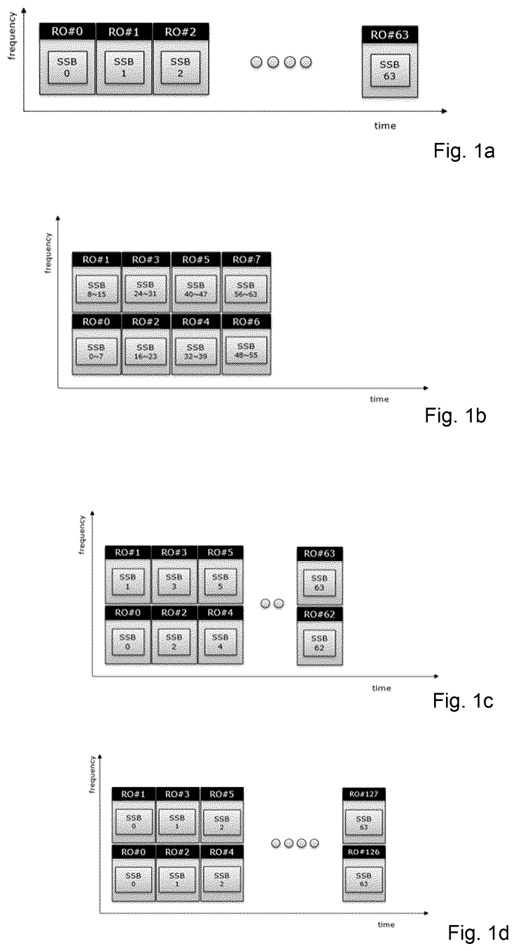

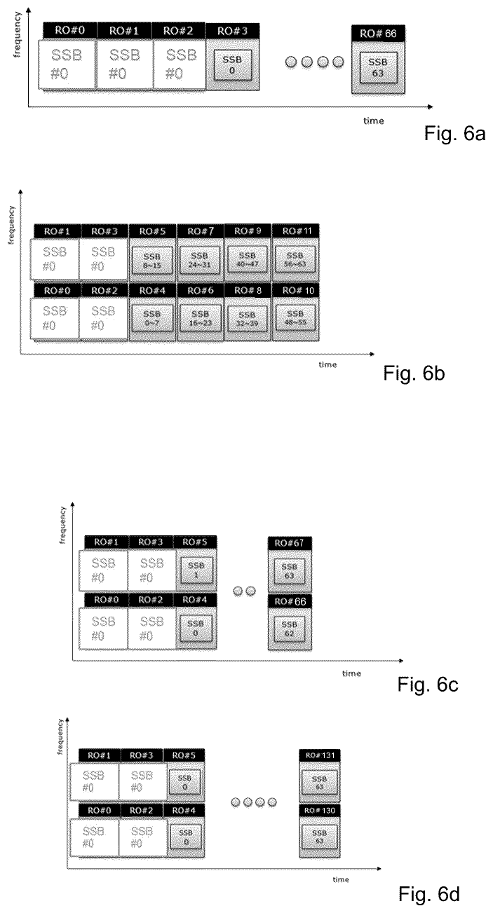

FIG. 1a to 1d show schematically examples of the frequency-time-domain of RACH occasions RO according to the 3GPP 5G NR implementation, as already explained before. In comparison to these figures, FIG. 6a to 6d show the frequency-time-domain of RACH occasions RO according to an embodiment of the invention. The RCC-parameters “msg1-FDM” and “ssb-perRACH-OccasionAndCB-PreamblesPerSSB” according to the 3GPP 5G NR implementation correspond identically to those described with respect to FIGS. 1a to 1d, respectively. Thus, there are provided according to the 3GPP 5G NR implementation 64 RACH occasions in FIGS. 6a, 7 RACH occasions in FIGS. 6b, 64 RACH occasions in FIG. 6c, and 128 RACH occasions in FIG. 6d, identically to FIG. 1.

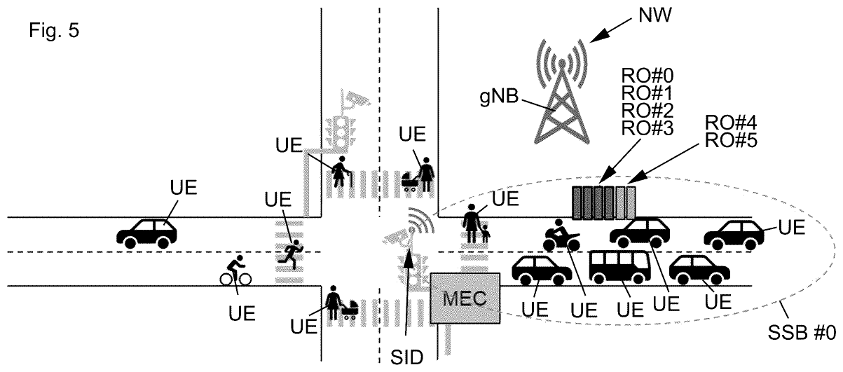

However, for the beam correlated to the sync signal SSB #0 (and the related geometrical area of the cell), the base station gNB of the communication network has received a message from a smart infrastructure device (SID) indicating critical events in the geographical area of the communication network cell related to the sync signal SSB #0. Accordingly, the base station gNB has activated new resources of the wireless communication network (NW) to be used by user equipment devices (UE), these resources being in the example of FIG. 6a three additional RACH occasions RO #0, RO #1, RO #2, all in the geographical area related to sync signal SSB #0 (as indicated in FIG. 5. These may be used as prioritized random access occasions for urgent access of user equipment devices of participating members such as cars, motorcycle, bus and/or smartphone carried by pedestrians have installed a suited application to participate in the proactive mobile network-assisted incident management.

In the examples of FIGS. 6b, 6c and 6d, four additional RACH occasions RO #0, RO #1, RO #2, RO #3 in the geographical area related to sync signal SSB #0, which max have been pre-configured by the base station gNB, are activated and communicated. Two of the additional RACH occasions RO #0, RO #1 may be labeled or used for prioritized random access, the additional RACH occasion RO #2 may be used for an ordinary additional access (to avoid congestion due to many potential user equipment devices UE requesting access, and the additional RACH occasion RO #3 may be assigned to radar systems for sensing to avoid interference of radar sensor signals.

The wireless communication network may be an LTE network or some other wireless network, such as LTE, 5G or 5G NR (New Radio) network. The wireless network may include one or more base stations. The base station may be referred as BS, NB, eNodeB (or eNB), gNodeB (or gNB), an access point or the like, depending on the wireless standard implemented. A base station provides radio communication coverage for a particular geographic area called “cell”. In this text, base stations are denoted as gNB.

User equipment (UE) may be referred as a mobile station, a wireless terminal, or the like. In some examples, user equipment may be a cellular phone, a wireless modem, a wireless communication device, a handheld device, a laptop computer or the like. User equipment may also be an IoT (internet of things) device, like wireless camera, a smart sensor or smart meter, a vehicle, a global positioning system device, or any other device configured to communicate through a wireless network.

User equipment may support various communication modes, such as a connected mode (RRC Connected), an inactive mode (RRC Inactive), or an idle mode (RRC Idle) as defined by 3GPP. When operating in RRC Connected mode, user equipment is active and communicate with base station. User equipment may transition from communication mode to another using various commands and messages received from the base station. For example, user equipment may switch from RRC Connected state to RRC Inactive state upon receiving a RRC Release message including suspendConfig parameter.

User equipment may enter RRC Inactive state without completely releasing radio resources when there is no traffic, in order to quickly switch back to RRC Connected states when necessary. In this case, user equipment and base station may store a context for the user equipment, for example an access stratum (AS) context, in order to apply said stored context when transitioning from RRC Inactive to RRC Connected state and thus reduce latency and signaling overhead. Such context may include Radio configuration parameters, such as uplink grant, RNTI (Radio Network Temporary Identifier), MCS and/or the like.

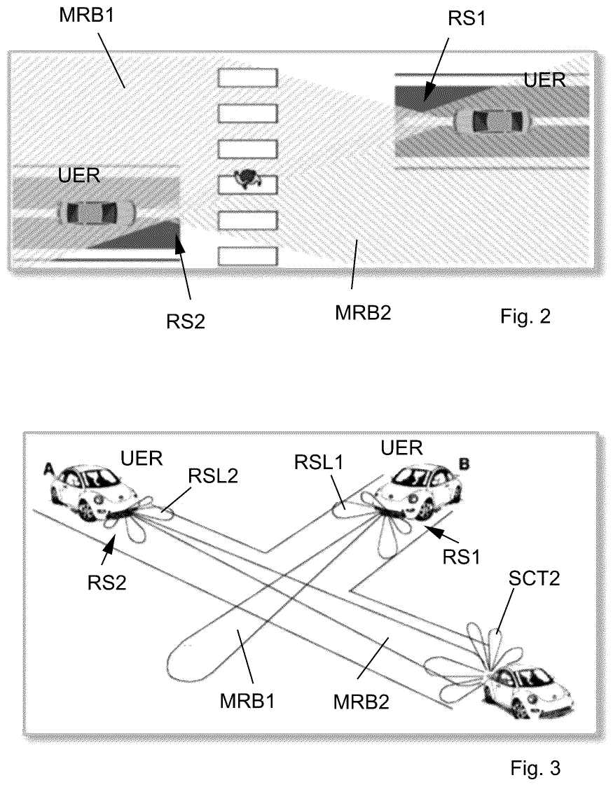

FIG. 2 shows schematically interference among automotive radars according to one exemplary situation, where two cars approaching each other are equipped with driver assistance systems (ADAS), in this case radar systems RS1, RS2 with interfering main radar beams MRB1, MRB2. Perception of car surroundings is key for advanced driver assistance systems (ADAS) and automated driving. Sensing systems include radar, lidar, camera, and ultrasound sensors. Automotive radar systems create mutual interference which may lead to misinterpretation of the resulting signals and degrade performance.

FIG. 3 shows schematically a similar situation with two cars B, A each having a radar system RS1, RS2, respectively. Each radar system RS1, RS2 has a main radar beam MRB1, MRB2 and radar side lobes RSL1, RSL2. Main radar beam MRB2 captures another car. This results in scattering SCT2 from the main radar beam MRB2. As both cars B, A are approaching the same intersection, main radar beams MRB1 and MRB2 cross each other at the intersection which may lead to interference. Accordingly, interference among automotive radars is a problem.

In this embodiment of the invention, each of the radar systems RS1, RS2 is part of a radar user equipment (UER) communicatively coupled to a wireless communication system not shown in FIGS. 2 and 3. The base station gNB recognizes the interference of the radar systems RS1, RS2 and indicates to one radar user equipment (UER), which radio resources and/or channels of the wireless communication network may be used for radar purposes.

In this embodiment, radio resources of the communication network are assigned for radar use. Radar systems RS1, RS2 are vendor-specific, but applicable radio spectrum is defined in a harmonized manner, typically in mmWAVE bands. Using smart infrastructure, system radar users UER in certain geographical area (e.g., SSB #x) are detected. The base station gNB determines and indicates to radar users UER (via SIB or UE-specific paging or signaling) which radio resources/channel to be used, e.g., for specific radar technology (e.g., FMCW, OFDM) in certain geographical area (e.g., SSB #x).

More specifically, the base station (gNB) determines to use part of the radio spectrum originally assigned for wireless communications (e.g., uplink, sidelink) for radar usage instead.

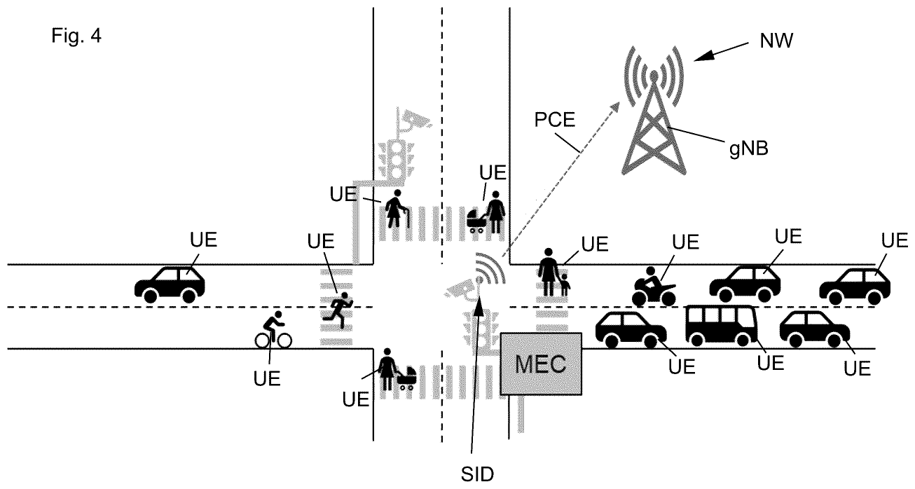

FIG. 4 shows a smart infrastructure device (SID) equipped with object detection sensors and data processing unit, e.g., a Multi-access Edge Computing (MEC) entity. An embedded AI algorithm will detect, classify, and track objects in or around the smart infrastructure device (SID), in the example shown an intersection. The smart infrastructure device (SID) predicts critical events (PCE) in said geographical area and sends said one or more predicted critical events (PCE) to the wireless communication network (NW), i.e., typically to the base station (gNB) of the network (NW).

In the example shown, the smart infrastructure device (SID) recognizes, on the right-hand side of the figure, a road with a high volume of traffic and a large number of different road users, such as cars, bus, motor cyclist and pedestrians, all of which may be equipped with a user equipment (UE). This critical situation is sent to the base station gNB as predicted critical event (PCE).

FIG. 5 shows scenario of FIG. 4 with the reaction of the base station gNB to the predicted critical events (PCE) sent by the smart infrastructure device (SID) to the network (NW), i.e., after the smart infrastructure device (SID) has provided the network NW with the predictions (PCE). The network NW (or more specifically, the base station gNB) assigns prioritized or more random access channel occasions (RO #0, RO #1, RO #2, RO #3) to geographical area identified by SSB #0, where critical events (PCE) are predicted. These additional random channel access occasions are shown in FIG. 6d, in addition to the normal random access channel occasions (RO #4, RO #5) provided according to a standard 3GPP 5G NR implementation. In this embodiment more ROs for SSB #0 are assigned by the network to provide more possibilities for faster access of user equipment (UE), in order to receive critical alerts faster as provided by a standard implementation. The base station (gNB)/network (NW) explicitly indicates to the user equipment (UE) which resources to be used for random access (PRACH). For example, at initial or random network access of the user equipment (UE), random access occasions (ROs) are pre-configured by the base station (gNB)/network (NW). Here, the base station (gNB)/network (NW) indicates which ROs are to be used by default and which ones for special events. When triggered by a prediction event, the base station (gNB) will activate on the fly the ROs for special events.

The apparatus comprises a processor and a memory, for example a Random Access Memory (RAM). The processor may be controlled by a computer program stored in the memory comprising instructions configured to implement a method for receiving Small Data Transmission (SDT) from a base station in a wireless communication network. More precisely, the computer program comprises instructions for receiving a paging notification from a base station while in inactive state, the paging notification comprising at least an indication that downlink small data is available for transmission, and a priority flag associated with said downlink small data, to determine at least a Synchronization Signal Reference Signal Received Power, and to postpone downlink data reception until next paging cycle when said priority flag indicates low priority downlink data and said at least a Synchronization Signal Reference Signal Received Power is below a threshold.

On initialization, instructions of the computer program may be loaded into the memory before being executed by the processor. The processor implements the steps of the method according to the instructions of the computer program.

The apparatus comprises a wireless communication unit, for example a 3G, 4G, 5G, 5G NR, WiFi or WiMax transceiver for exchanging messages with other apparatus. In particular, communication unit is configured by program instructions to receive a paging notification broadcasted by a base station and check if the received paging is addressed to the apparatus by comparing an identifier comprised in said paging notification with an identifier associated with the apparatus. The communication unit may be further configured to obtain an indication from said paging notification, regarding a priority associated with available small data. This indication may be a binary flag included in a PagingUE-Identity data field of the paging notification wherein the flag is set to indicate high priority small data.

All cited approaches of the embodiments can be combined together with all the others disclosed accordingly.

This feature is most beneficial for sensors, IoT devices, and even messaging and presence applications in smartphones.

1. A method for proactive mobile network-assisted incident management by a smart infrastructure device connected to a wireless communication network, wherein the smart infrastructure device detects, classifies, and/or tracks objects in or around a geographical area, predicts critical events in said geographical area and sends the one or more predicted critical events to the wireless communication network, and wherein the wireless communication network, in particular a base station of the wireless network, explicitly indicates which resources of the wireless communication network are to be used by user equipment.

2. The method according to claim 1, wherein explicitly indicating comprises to assign additional and/or prioritized random access channel occasions for use by user equipment in said geographical area for initial and/or random access to the wireless communication network.

3. The method according to claim 2, wherein said additional and/or prioritized random access channel occasions are pre-configured and indicated to the user equipment by a base station of the wireless communication network.

4. The method according to claim 3, wherein the base station indicates which random access channel occasions are to be used by default and which ones are to be used for special events, whereby these events can be based on historical event data, or when triggered by a predicted critical event.

5. The method according to claim 2, wherein the base station activates and/or communicates said additional and/or prioritized random access channel occasions on the fly, if a predicted critical event is received by the wireless communication network.

6. The method according to claim 1, wherein predicting critical events is realized in a user equipment, in a base station and/or another wireless communication network device, such as a smart infrastructure device equipped with at least one object detecting sensor and a data processing unit.

7. The method according to claim 1, wherein, if at least one user equipments connected to a wireless communication network are radar user equipments, the base station indicates to said radar user equipments, which radio resources and/or channels of the wireless communication network may be used for radar purposes.

8. The method according to claim 7, wherein the base station reserves part of the radio spectrum originally assigned for wireless communication for radar usage.

9. The method according to claim 8, wherein said part of the radio spectrum is flexibly chosen from radio resources, in the form of at least one of time, frequency, spatial, directional, and code, of the wireless communication network spectrum based on information or predicted critical events that are provided by a smart infrastructure device.

10. The method according to any claim 7 wherein the base station indicates the radio resources and/or channels to be usable for radar purposes to said radar user equipment in a communication via system information blocks or user equipment specific paging and/or signaling.

11. An apparatus for use in proactive mobile network-assisted incident management, said apparatus comprising a wireless transceiver for communicating in a wireless communication network, a processor coupled with a memory in which computer program instructions are stored, said computer program instructions being configured to cause the wireless communication network and/or a base station of the wireless communication network to perform operations comprising:
detecting, classifying, and/or tracking objects in or around a geographical area,
predicting critical events in said geographical area and sending the one or more predicted critical events to the wireless communication network, and
wherein the wireless communication network, in particular the base station of the wireless network, explicitly indicates which resources of the wireless communication network are to be used by user equipment.

12. (canceled)

13. A smart infrastructure device comprising one or multiple sensors, in the form of at least one of radar, camera, lidar, laser, and ultrasound, for detecting, classifying, and/or tracking objects, a wireless transceiver for communication in a wireless communication network, a processor coupled with a memory in which computer program instructions are stored, said computer program instructions being configured to predict critical events in a geographical area and to provide corresponding event data to the wireless communication network, assigning additional and/or prioritized random access channel occasions for use by user equipment in said geographical area for initial and/or random access to the wireless communication network, and wherein a base station activates and/or communicates said additional and/or prioritized random access channel occasions on the fly, if a predicted critical event is received by the wireless communication network .

14. A radar user equipment comprising a radar sensor for detecting, classifying, and/or tracking objects in a radar sensor field, a wireless transceiver for communication in a wireless communication network, a processor coupled with a memory in which computer program instructions are stored, said computer program instructions being configured to receive indications of a base station of the radar sensor, wherein, if at least one user equipment connected to a wireless communication network is radar user equipment, the base station indicates to said radar user equipment, which radio resources and/or channels of the wireless communication network may be used for radar purposes, and to adapt the radar sensor to use the indicated radio resources and/or channels of the wireless communication network for radar purposes and/or radar communication.

15. A user equipment comprising a wireless transceiver for communication in a wireless communication network, a processor coupled with a memory in which computer program instructions are stored, said computer program instructions being configured to receive indications of a base station of using additional and/or prioritized random access channel occasions.

16. A wireless communication system for proactive mobile network-assisted incident management comprising a base station and at least one user equipment device, wherein said user equipment device comprises a processor coupled with a memory in which computer program instructions are stored, said instructions being configured to implement communication with a wireless communication network, wherein the base station is configured to participate in proactive mobile network-assisted incident management by a smart infrastructure device connected to the wireless communication network, wherein the smart infrastructure device detects, classifies, and/or tracks objects in or around a geographical area, predicts critical events in said geographical area and sends the one or more predicted critical events to the wireless communication network, and wherein the wireless communication network, in particular the base station of the wireless network, explicitly indicates which resources of the wireless communication network are to be used by user equipment.

17. The wireless communication system according to claim 16, wherein one of the user equipments comprises a wireless transceiver for communication in the wireless communication network, a processor coupled with a memory in which computer program instructions are stored, said computer program instructions being configured to receive indications of a base station of using additional and/or prioritized random access channel occasions.
